(19) United States
(12) Patent Application Publication
(10) Pub. No.: US 2002/0090104 A1
(43) Pub. Date: Jul. 11, 2002

(54) Earphone

(76) Inventor: Hsi Kuang Ma, Taipei (TW)

Correspondence Address: Dougherty & Troxell, ONE SKYLINE PLACE, SUITE 1404, 5205 LEESBURG PIKE,, FALLS CHURCH, VA, 22041, US

(21) Appl. No.: 09/765,326

(22) Filed: Jan. 22, 2001

(30) Foreign Application Priority Data
Jan. 5, 2001 (TW) 90200216

(51) Int. Cl. H04R 25/00

(52) U.S. Cl. 381/374; 381/370

(57) ABSTRACT

An earphone comprises a voice part, and at least a decoration part. The voice part has a main body with voice generating elements therein and a connecting wire extends outward from the voice part. The main body at the outer side provides a engaging joint. The decoration part has an engaging device therein corresponding to the joint for engagement.

### BACKGROUND OF THE INVENTION

1. Field of The Invention

The present invention relates to an earphone, and particularly to an earphone with versatile decorative outer looks.

2. Description of Related Art

An earphone, especially the so-called earphone plug, is a voice receiver having been used for years. Due to popularity of the portable sound equipment such as portable stereo, the earphone has become one of essential component for the sound equipment. It is the reason why many users listen to the stereo by way of wearing the earphone regardless they are in the car, or the park, or on the street.

On the other hand, the earphone has been made very small in size under a pursuit of lightness, thinness, shortness, and smallness because of electronic technology and material science so as to be received in our ears completely. That is, the little earphone only provides a size like a pill so that it almost may not be seen except the connecting wire. Nevertheless, all component parts such as vibratory membrane and etc. are mounted in the little earphone in spite of its very small size, the required functions thereof can still work perfectly.

Although the miniature design of earphone is convenient for the user while wearing it, it does not mean the necessity of consumer for new and change is satisfied. Especially, a product with versatile combinations or a product with series has been developed in the recent years and is loved very much by the consumers. From a stand point of view of user with regard to a personal decorative article carried about for revealing individual interest, the earphone with monotonous flat and round shape is undesirable for the need of user naturally. Hence, this is a subject has to be broken through.

### SUMMARY OF THE INVENTION

An object of the present invention is to provide an earphone, which provides a decoration part with a changeable shape of doll for satisfying personal interest of user.

### BRIEF DESCRIPTION OF THE DRAWINGS

The present invention can be more fully understood by referring to the following description and accompanying drawings, in which:

FIG. 1 is an exploded perspective view of an earphone according to the present invention, and

FIG. 2 is a perspective view of the earphone shown in FIG. 1 after being assembled.

### DETAILED DESCRIPTION OF THE PREFERRED EMBODIMENTS

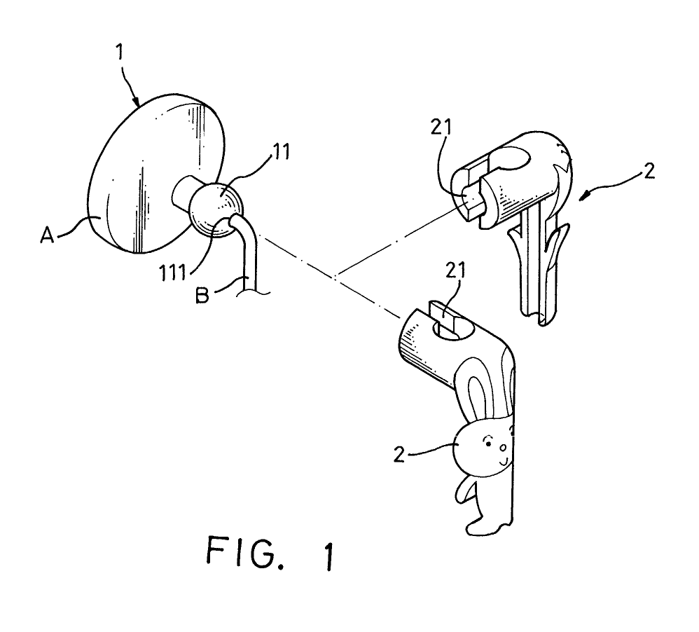

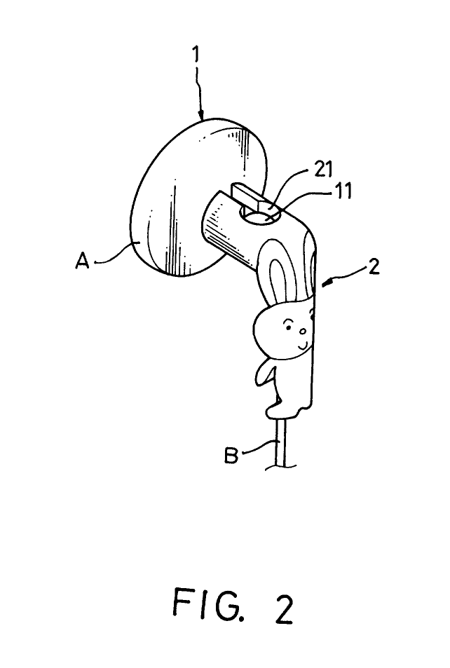

Referring to FIGS. 1 and 2, the earphone of present invention basically comprise a voice part 1, and at least a decoration part 2.

The voice part 1 is a conventional earphone, which has been mentioned above already. It is preferable that the size of voice part can be arranged to plug the external ear. Furthermore, the main body “A” provides conventional earphone components therein and joins a wire B extending outward for connecting with a receiver.

The main body “A” extends outward a joint 11 for locating the decoration part 2. The joint 11 illustrated in the embodiment of FIG. 1 is provided with a ball shape, and, it is only for taking example but not for a restriction. The wire “B” extends through a hole 111 on the joint 11 and alternatively, the wire “B” can be arranged to extend outward without any engagement relation with the joint 11.

The decoration part 2 basically has a configuration provided with a sense of modeling or visual pursuit. Thus, the configuration of decoration part 2 can be a doll of animal or other else design. A fitting groove 21 is, provided in the decoration part 2 for engaging with the joint 11 as a close fit without slip. As shown in FIGS. 1 and 2, the decoration part 2 is provided with an enlarged end and this is only for taking example and not for restriction. In case of the wire “B” extending outward from the joint 11, the hole 111 can be provided to pass through the wall of joint 11 at a lateral side thereof or pass through the joint transversely. Hence, decoration part 2 can be an integral piece or composed of two pieces or more.

Referring to FIG. 2 again, the decoration part 2 engages with the joint 11 on the voice part 1 by way of the fitting groove 21. Thus, an earphone with decorative outer look can be formed interestingly.

Because the decoration part 2 can be made with a series of different outer looks such as twelve animal signs, constellation, and etc., the user is able to pick a favorite one based on personal interest or wear them alternately. In this way, it is possible to satisfy the desire of user for novelty and allow the earphone offering an additional function except the voice receiving.

While the invention has been described with reference to preferred embodiment thereof, it is to be understood that modifications or variations may be easily made without departing from the spirit of this invention, which is defined by the appended claims.

What is claimed is:

1. An earphone, comprising
a voice part, having a main body with voice generating element therein and a connecting wire extending outward, and providing a joint at an outer side thereof;
at least a decoration part, having an engaging device therein corresponding to the joint for engagement.

2. The earphone according to claim 1, wherein a through hole is provided in the joint for the wire to extend through.

3. The earphone according to claim 2, wherein the joint is made integrally with the main body to project outward from the main body.

4. The earphone according to claim 1, wherein the joint is cylindrical with a ball end.

5. The earphone according to claim 1, wherein the engaging device in the decoration part comprises a groove.

6. The earphone according to claim 1, wherein the decoration part may provide a configuration with a series of doll modeling.

7. The earphone according to claim 1, wherein the engaging device of said decoration part is a groove piercing a lateral portion of the decoration part for the wire passing through and extending outward.

8. The earphone according to claim 1, wherein the engaging device of said decoration part is a groove piercing through the entire decoration part transversely for the wire passing through and extending outward.
